(19) United States
(12) Patent Application Publication
(10) Pub. No.: US 2009/0144139 A1
(43) Pub. Date: Jun. 4, 2009

(54) SYSTEM AND METHOD OF FACILITATING COMMERCIAL TRANSACTIONS USING CONTENT ADDED TO WEB SITES

(76) Inventor: Dewey Gaedcke, Austin, TX (US)

Correspondence Address: JOHNSON & ASSOCIATES, PO BOX 90698, AUSTIN, TX, 78709-0698, US

(21) Appl. No.: 11/947,760

(22) Filed: Nov. 29, 2007

(51) Int. Cl. G06Q 30/00

(52) U.S. Cl. 705/14

(57) ABSTRACT

A method and apparatus is provided for use in facilitating commercial transactions using content added to web sites. In one example, content added to web sites includes one or more coupon widgets selected by the profile owner. In the context of social networks, the invention provides tools for businesses that leverage word of mouth marketing with their loyal customers.

### FIELD OF THE INVENTION

This invention relates to systems and techniques promoting goods and/or services using web sites. In particular, this invention is drawn to systems and methods for facilitating commercial transactions using content added to social networks and other web sites.

### BACKGROUND OF THE INVENTION

In certain types of businesses, revenue opportunities are lost if goods or services go unused during any given time. For example, when a hotel room is empty, an airplane takes off with an empty seat, a service provider is idle, etc., that revenue opportunity is gone for ever. Priceline revolutionized the process of using anonymous auctions to sell certain types of inventory at discounted rates without any negative brand consequence. This approach is possible because airlines and major hotels have sophisticated automated computer systems. However, nearly every business has slow times. For example, restaurants and bars commonly have empty seats that could be used by additional customers. Businesses that provide other goods and services (e.g., hair salons, car washes, home repair providers, etc.) also commonly have down times that could be used to provide goods or services to additional customers.

However, small local businesses typically do not have sophisticated computer systems that could facilitate a system similar to Priceline. In addition, small local businesses do not have the infrastructure and advertising or marketing budgets to take full advantage of their full capacity to provide goods or services. Typically, the most effective marketing channel for small local businesses is word of mouth referrals, but they have no way to motivate their best customers to spread the word or to measure the effectiveness of word of mouth referrals. While small local business desire to generate more traffic during low volume periods, limited advertising budgets hinder their efforts. Prior art marketing techniques, such as mailbox coupon packages, provide no guarantee of an effective return, and the coupons are rarely used by potential new customers. In addition, these types of marketing techniques provide a one time shot a customer's attention. As a result, these types of marketing efforts are frequently unsatisfactory.

There is a need for innovative marketing techniques for promoting commercial transactions that provides improvements over the prior art.

### SUMMARY OF THE INVENTION

A method of the invention is provided for facilitating a commercial transaction including providing a coupon production infrastructure allowing users to generate content that will be added to one or more web pages relating to a respective user when other users view the one or more web pages on an internet client, allowing a first user to place content related to a coupon that will be associated with a first web page, when a second user views the first web page using an internet client, adding the content placed by the first user, enabling the second user to view information relating to the content placed by the first user, and allowing the second user to generate a coupon based on the viewed information.

Another embodiment of the invention provides a wireless hand-held apparatus for facilitating commercial transactions including a processor for processing information, one or more user interface devices, a storage device for storing information, a display for displaying information, a sensor for reading machine readable information on a coupon generated by a customer in response to the customer viewing a profile page of a profile owner, wherein the coupon was generated based on coupon content added to the profile page by the profile owner, and a transceiver for allowing the apparatus to communicate wirelessly with an application server, wherein the wireless hand-held apparatus communicates with the application server to verify the validity of the coupon.

Another embodiment of the invention provides an apparatus including an application server, a database coupled to the application server for storing information relating to a plurality of profile owners, wherein for each of the plurality of profile owners, the database stores coupon related content selected by the respective profile owner, and wherein the stored coupon related content is intended to be displayable in conjunction with one or more web pages or profiles, and wherein the application server is configured to receive requests from internet clients whether web pages identified by the web clients correspond to any web pages identified in the database, such that a web page can be displayed by a respective internet client with coupon related content added from the database.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIGS. 1-2 are block diagrams of examples of the present invention implemented in a network environment.

FIG. 3 is a flowchart illustrating one example of a process of a profile owner generating coupon related content to be displayed with a profile web page.

FIG. 4 is a flowchart illustrating one example of a process for displaying profile owner generated coupon content along with a profile web page.

FIG. 5 is a flowchart illustrating one example of a coupon use process.

FIG. 6 is a diagram of a web browser, as it would be viewed by a user of a network client.

FIG. 7 is a diagram of a web browser, with a toolbar (and underlying web page) placed in an edit mode.

FIG. 8 is a diagram of a web browser, illustrating a coupon widget and possible anchor points.

FIG. 9 is a diagram of a web browser, illustrating a view as the coupon widget is dragged toward an anchor point.

FIG. 10 is a diagram of a web browser, illustrating a view of a coupon widget anchored in place.

FIG. 11 is a diagram of a web browser, illustrating the addition of the coupon widget.

FIG. 12 is a block diagram of one example of a wireless handheld barcode scanner.

FIG. 13 is a flow chart illustrating a process for providing automated appointments.

### DETAILED DESCRIPTION

In some examples, the present invention relates to techniques for facilitating commercial transactions with users of social networks and other web sites. For example, in the context of social networks, the invention provides tools for businesses that leverage word of mouth marketing with their loyal customers. To help with the understanding of the description of the invention, a brief description of social networks follows.

Generally, a social network is a social structure consisting of individuals or organizations. Users of social networks are connected together through various social familiarities such as friends, family, acquaintances, users having similar interests, etc. In an Internet environment, social networking typically refers to web sites that help users connect to friends, business acquaintances, etc.

A typical social network in an Internet environment frequently offers users places to store and post profiles, blogs, groups, photos, videos, etc. A typical user profile in a social network may include sections about interests of the user such as music, books, movies, marital status, physical appearance, etc. Some social networking sites also allow users to organize links to their friends' from that particular social network as a “friends list”. Examples of typical Internet based social networks include MySpace, Facebook, Match, Classmates, Friendster, LinkedIn, orkut, Youtube, Xanga, etc.

In one example of the present invention, an infrastructure is provided for generating and tracking the use of coupons (for example, defined as an incentive based offer for a discount against goods and/or services within certain specific terms and conditions), for the purpose of promoting businesses. In contrast to typical mailbox coupons, the present invention provides a more efficient, less expensive, and more effective system by leveraging word of mouth marketing with a business' loyal customers. In one example, a customer is encouraged to participate via paid referrals that generate sales. With typical prior art systems, this would be a difficult challenge. For example, it is not practical for a business to expect its' customers to carry coupons around and hand them out in public, or to remember to bring up the “endorsement” in conversation, or to make the effort to track and collect their referral income. The present invention overcomes these problems by providing an infrastructure that does not have these disadvantages.

In the exemplary context of social networks, an infrastructure is provided that makes it relatively easy for loyal business customers to put a coupon generator on their social networking page. In one example (described in detail below), the system of the present invention provides a platform that: works across all social networking web sites (as well as other desired web sites); can not be blocked by web site providers; knows its users' identities in each on-line community; has a consistent management and accounting layer; is easy to use (for the businesses, referring customers, and new customers; and can validate coupons for legitimacy, at the same time that it accounts for a transaction. One example of a platform that can be used with the present invention is described in detail in co-pending, commonly owned U.S. patent application Ser. No. 11/556,586, publication Ser. No. ______, entitled “METHOD FOR DISPLAYING USER GENERATED CONTENT IN A WEB BROWSER,” which is incorporated by reference herein. In one example, a widget (aka, small web application) is provided that allows users to endorse/evangelize local businesses from their favorite social networking profile(s).

In one example, the present invention works as follows. First, an infrastructure is provided that allows profile owners in social networks and other web sites to easily place coupon production tools on their page to promote businesses of their choice. A profile owner can use a web tool, to place a coupon widget (which generates coupons) relating to a discount or promotion for a particular merchant or business. In one example, the generated content is added (for example, via an overlay per the previously referenced patent application publication) to the profile owner's social networking page, and displayed in the browsers of other users (described below). In this way, the profile owner maintains control of the generated content, so as not to be impeded by the web site provider. When a user views the profile owner's social networking page, the user's browser injects the generated content, and the content is displayed with the web page. If desired, the user can then generate a coupon, as defined by the generated content (aka, coupon widget). In one example, a coupon printed on paper is generated. Other examples are described below. The coupon may include any desired information, including a bar code and/or identification number. When the user presents the coupon to the merchant, the merchant scans the barcode, the coupon is validated, and the user gets the discount defined by the coupon. In the background, the coupon infrastructure tracks the use of the coupon and initiates any desired accounting procedures. In one example, the processing of the coupon obligates the merchant to pay a predetermined fee. The fee collected from the merchant can be split between the infrastructure provider, the profile owner, and potentially a person responsible for affiliating the merchant with the coupon production infrastructure. In another example, the coupon consumer may receive a percentage of the discount at point of sale, and a further refund amount when they later complete an online survey or feedback form which summarizes their experience with the merchant.

The following description illustrates examples of environments in which the present invention may be used. Of course, the invention may also be used in other types of environments. In the example of a web environment, the present invention provides an infrastructure, used in conjunction with network clients, to facilitate commercial transactions (e.g., the use of coupons to promote businesses). The infrastructure may include a network(s), network clients, web servers, application servers, and associated items (including hardware and software). In addition to tools for end-user creation and configuration of coupon widgets for display on web pages, the infrastructure may include tools to facilitate the display of generated content generated by users or tools to track coupon consumption. Examples of tools include, but are not limited to, Internet browser toolbars, browser extensions, browser plug-ins, barcode scanners, executable programs that communicates with the browser, etc.

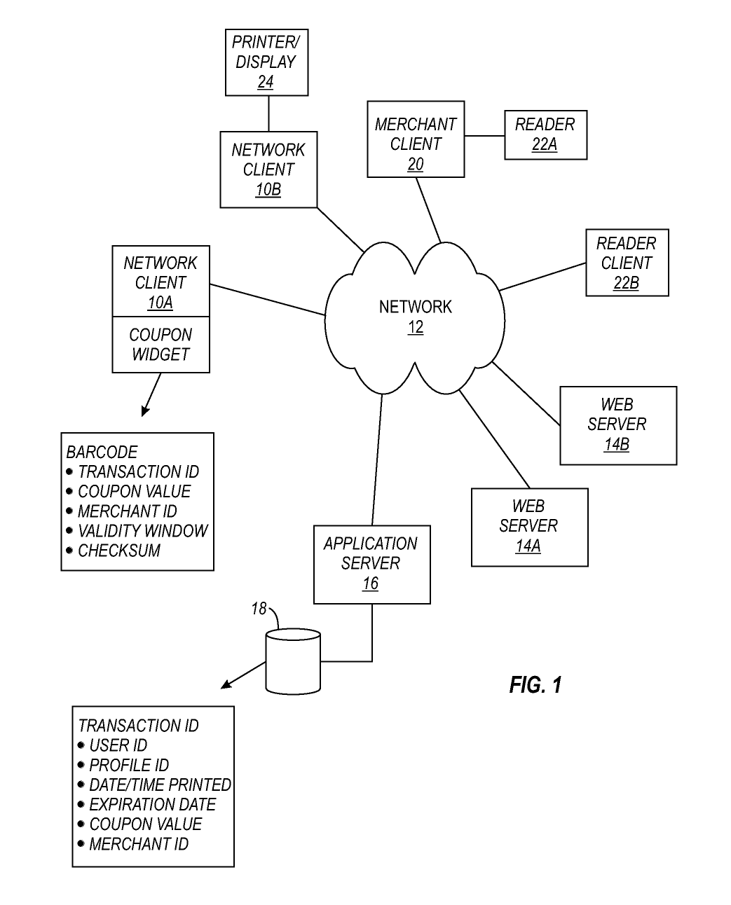

FIGS. 1-2 are block diagrams of examples of the present invention implemented in a network environment. FIG. 1 is a block diagram showing a plurality of network clients 10 coupled to a network 12. The network 12 may include the Internet, intranets, wired or wireless networks, POTS networks, cellular networks, pager networks, etc. The network clients 10 may be comprised of any desired type of client, such as a computer, phone, PDA, network appliance, etc. A typical network client may include a processor(s), a storage device(s) (memory, hard drive, etc.), user interface device(s) (e.g., keyboard, keypad, mouse, etc.) and a display. A plurality of web servers 14 are also coupled to the network 12. The web servers 14 each host one or more web sites, which may be accessed and viewed by internet browsers installed on the internet clients 10. An application server 16 is also coupled to the network 12. The application server 16 has access to a database 18 (described below). One or more merchant network clients 20 are also coupled to the network 12. A merchant network client 20 may also be comprised of any desired type of client. A reader 22A is coupled to the merchant client 20. The purpose of the reader 22 is to read a coupon presented by a user. In one example, a reader 22 is comprised of a bar code reader capable of scanning a bar code printed on a paper coupon or displayed on an electronic display. A reader 22 could also be comprised of any other device capable of reading information on a coupon. A reader 22 can be used on conjunction with a network client (e.g., reader 22A), or can be a device that is a network client itself (e.g., reader client 22B). In another example, a reader 22 could involve the use of manual steps, such as manually entering information into a keypad or verbally conveying information.

A first network client 10A represents the web client of a profile owner who generates coupon related content to be displayed with a (their) profile page. A coupon widget is provided that allows the profile owner to easily generate content relating to a coupon for a merchant (described below). In one example, the coupon content includes a transaction ID generator (at print time), the coupon value (i.e., the value of a price discount), a merchant ID (identifying the merchant), a validity window (e.g., dates/times in which the coupon will be valid), and a checksum value (to help validate a presented coupon). The database 18 will store information relating to each transaction ID, including a user ID, (e.g., identifying a user), profile ID (e.g., associating a user with a profile on a social network), the date/time that the coupon is generated or printed, an expiration date of the coupon, the value of the coupon, and the merchant ID.

A second network client 10B represents the web client of a user (a potential customer of the merchants) who generates a coupon based on the coupon related content (coupon widget) from the profile owner, while viewing the profile owner's profile. The network client 10B is coupled to a printer/display 24, which can be used to visually depict the generated coupon. In one example, a coupon is printed on paper. In another example, a coupon is displayed on a display (e.g., a display on a PDA, phone, etc.). In another example, a generated coupon is simply an entry in a database (e.g., database 18), which the merchant will be able to access to allow the user to use the coupon. Note that each network client 10 can be the client of both a profile owner (that can place content) and a potential customer (that can generate coupons from the pages of other profile owners).

When a user of a network client 10B requests to view a web page hosted by one of the web servers 14A or 14B, the web browser of the network client 10B will send a request to the appropriate web server 14, which will send web page html content back to the network client 10B, where the content will be rendered and displayed for the user. By accessing the application server 16, the tool (e.g., software, etc.) on the network client 10B is able to provide the user with various additional functions (described in detail below). For example, the database 18 may store additional content (e.g., the coupon content generated by the profile owner) that has been associated with the web page (or portions thereof) retrieved from one of the web servers 14.

FIG. 2 is a block diagram of an example of the present invention implemented in a network environment using one or more social networks. Like FIG. 1, FIG. 2 shows a plurality of web servers 14 coupled to the network 12 (e.g., the Internet). In this example, the web servers 14A and 14B each host social networking web sites. FIG. 2 also illustrates that the web servers 14A and 14B each host web pages that contain profile information relating to users of the social networks. FIG. 2 shows a network client 10B coupled to the network 12. Note that, for clarity, only one network client 10 and one merchant are shown in FIG. 2, although any desired number of network clients and merchants may be included. An application server 16 and database 18 are also coupled to the network 12.

In the example illustrated in FIG. 2, software installed on the network client 10, along with the application server 16, provide the network client user with enhanced features, which facilitate the display of coupon related content and coupon generation. For example, when the user (a potential customer of the merchant) views a web page containing profile information, the network client 10B will display the web page, along with profile owner generated content (including coupon related content), that is stored in the database 18. If no such content exists, the network client 10 will simply display the web page provided by the corresponding web server 14. Note that, with the invention, the application server 16 and database 18 can provide owner generated content for multiple web pages over multiple social networks. The term “profile owner” is intended to refer to a person or user that has at least partial control over the content that appears on the native web page.

When the user of the network client 10B views the web page, along with the profile owner generated coupon content, the user has the option of generating the coupon for use with the merchant. If desired, the user can be forced to complete one or more processing steps before the coupon is generated. In one example, the user can simply click a button or link that generates the coupon. In other examples, more may be required of the user. In one example, the user must view an advertisement prior to generating a coupon. In another example, the user must view a video clip or listen to an audio clip prior to generating a coupon. In another example, the user must participate in a survey prior to generating a coupon. In another example, the user must refer another user to a service prior to generating a coupon. Once the user has competed any required steps, the coupon can be generated. As mentioned, coupon generation can take on many forms. In one example, a coupon can be printed on paper, etc. In another example a coupon can be stored and displayed on a display (e.g., on a phone, PDA, multimedia device, etc.).

When the user wishes to use the coupon, the coupon is presented to the merchant. In one example, a coupon (e.g., on paper, on a display, etc.) is presented to the merchant, and the merchant reads/scans the coupon using the reader client 22B. When the reader client 22B reads/scans the coupon, several procedures can be initiated, as desired. In one example, the reader client 22B communicates with the application server 16 to verify the validity of the coupon and log the transaction. In one example, the checksum value is used, along with the transaction ID to verify the validity of the coupon. The application server 18 can also provide the merchant with a confirmation of the value of the discount. In the background, the application server can initiate any desire financial transactions, such as debiting the merchant account for a referral fee and crediting the accounts of the profile owner and the salesperson (e.g., the person who signed up the merchant).

Following are more details relating to how content can be displayed when a user views a web page. As mentioned above, the present invention relates to the control of content on a social networking (or other) web site. In a typical social networking web site, when a profile owner publishes content to their profile, all content is visible to the entire friends list or whole community. The present invention provides a way for a user to add content (such as coupon related content) to their profile, while maintaining control of the content visibility at a granular level. In one example, permissible content generated by the profile owner is injected into the profile page of any desired social networking web site by the web browser and associated toolbar of the user viewing the profile page. This content can be viewed by other users, without altering the original content of the profile page hosted by the social networking web site. Other users of the present invention are able to view the owner generated content (assuming they have permission) while they are viewing the original profile web page. For example, a first profile owner can add private content to his or her profile page. Someone not using the appropriate software would not even know that the owner generated content existed. However, someone using the appropriate software, if authenticated, would know and see the added content. The network client can be configured to display the content in any desired manner. For example, the owner generated content could be displayed automatically when a user visits the corresponding web page, or the user may just be notified that owner generated content existed, allowing the user to choose whether or not to view the additional content.

One option relating to the use of profile owner generated content relates to controlled access of the content. In one example, a profile owner may not care if everyone can view the owner generated content. In this example, no permission would be required to view the owner generated content, and anyone with the appropriate software could view it. In another example, a profile owner may only desire certain people to view the owner generated content. The invention allows the owner generated content to be viewed by only people having proper permissions, records or attributes. Access to owner generated content can be controlled using various techniques such as: passwords, specific user permissions, group permissions, age verifications, time restrictions (e.g., the content may only be visible during certain times), personal attributes, digital certificates, etc., as well as any combination of these and other techniques. In some social networks, profile owners maintain a list of friends or contacts. In one example, the profile owner may configure the owner generated content to only be available/visible to people (or subsets of people) in the owner's list of contacts. Note that an owner may have multiple contact lists. For example, the owner may have friends list from various social networking web sites, as well as one or more “multi-site friends lists.” The user permission status may be based on any list, or combinations thereof. In another example, authorization to access owner generated content can be based on any number of a user's many profile attributes. For example, a user may have his/her own profile page containing various profile attributes. A profile owner can specify that certain owner generated content be accessible to users whose profile attributes meet one or more requirements (e.g., fall within a specified age group, be from a specified city or area, have specified interests, etc.). Examples of profile attributes may include account information, attributes from one or more registered profiles, tags, comments other people have made about a user, application usage history, etc. Also note that different sets of attributes (i.e., filters) can be applied individually to different content blocks. For example, a profile owner can configure one content block to be visible to people in a particular zip code, and another content block to people that have a registered profile with a particular social network. Numerous other examples are also possible.

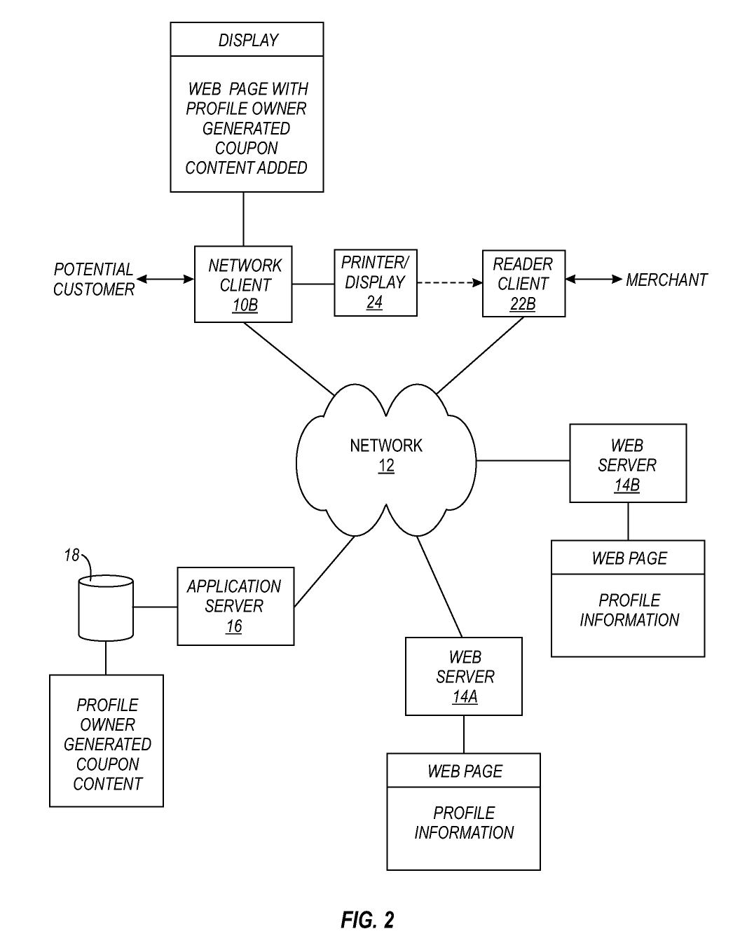

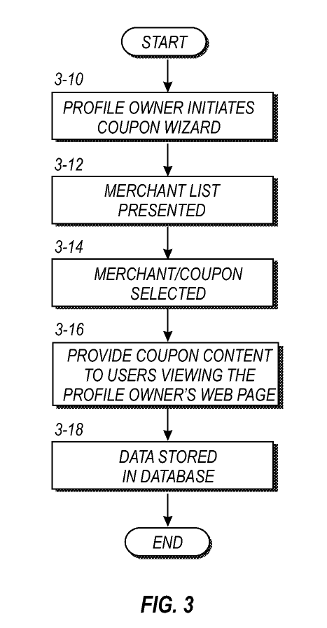

FIG. 3 is a flowchart illustrating one example of a process of a profile owner generating coupon related content to be displayed with a profile web page. While viewing their profile page, the profile owner initiates the coupon selection wizard (step 3-10). The profile owner's network client 10 then communicates with the application server 16. Next, at step 3-12, a list of merchants is provided for the profile owner to choose from. The list of merchants can be presented as a single list, as a searchable list, as categorized lists, etc. Alternately, a merchant/coupon can be selected automatically for the profile owner. At step 3-14, the profile owner selects a merchant/coupon from the available merchants and displays it on his profile page. At step 3-16, the coupon content is provided to any authorized network client that views the profile owner's web page (see FIG. 4). When another user (using an authorized network client) visits this profile pages, and clicks to print the coupon, at step 3-18, the application server 16 stores the corresponding data (e.g., transaction ID, a user ID, profile ID, the coupon expiration date, the value of the coupon, and the merchant ID) in the database 18.

FIG. 4 is a flowchart illustrating one example of a process for displaying profile owner generated coupon content along with a profile web page. However, the invention can be implemented using various other processes, as one skilled in the art would understand. The process illustrated in FIG. 4 begins at step 4-10, where a request for a profile web page is received by a web server 14. At step 4-12, the requested web page is retrieved from the web server 14. These steps may be accomplished in any desired manner, such as by using HTTP protocol. At step 4-14, the retrieved structure of the web page is rendered and partially displayed on a web browser installed on the network client 10. Alternatively, the display of the web page could wait until all of web page content and owner generated content is received.

The next part of the process illustrated in FIG. 4 relates to determining whether owner generated content exists, whether the user of the network client is authorized to view the owner generated content, and displaying any owner generated coupon content. At step 4-16, the process asks whether any owner generated content is available. If it is determined (e.g., via a comparison to entries in the database 16) that no owner generated content is available, the web browser renders and displays the default web page normally (step 4-17), and the process ends. If owner generated content is available, the process proceeds to step 4-18. At step 4-18, the process asks whether the user has been authenticated to view the owner generated content. In other words, the process determines whether the profile owner has given (specifically or through attribute matching, for example) the user permission to view the owner generated content. If the user has not been authenticated, the process proceeds to step 4-17, where the web browser renders and displays the default web page. If the user is authenticated, the process proceeds to step 4-20, where the network client retrieves the owner generated coupon content from the application server. Next, at step 4-22, the owner generated coupon content from the application server is injected into the web page. At step 4-24, the web browser renders and displays an enhanced web page (e.g., the default web page from the web server, plus the coupon content). The owner generated content can be displayed in any desired manner. If the user desires, a coupon can be generated at step 4-26. As described above, coupon generation can involve printing a coupon on paper, storing information for display on a display, storing information in a database for future retrieval.

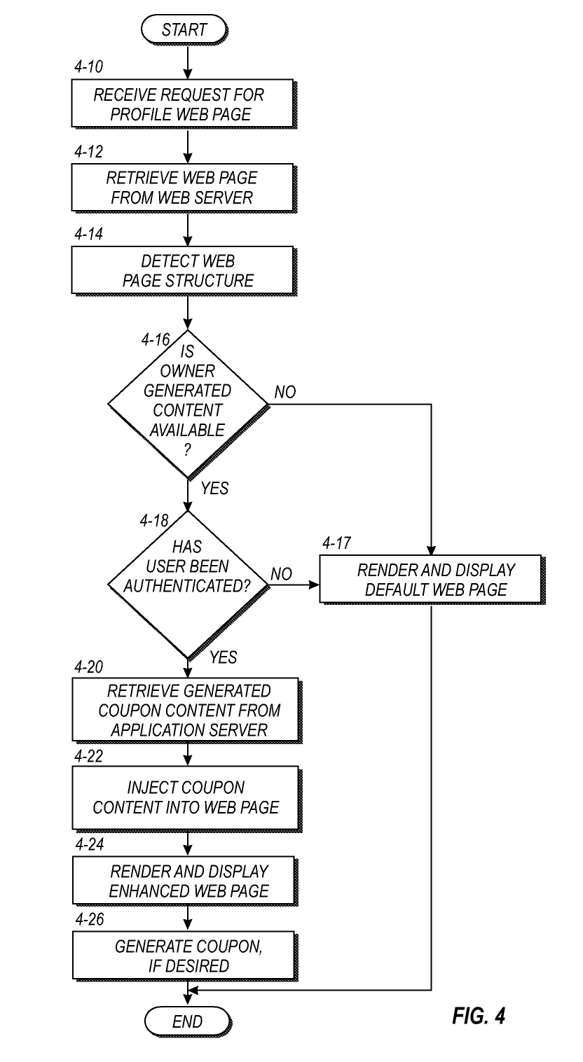

FIG. 5 is a flowchart illustrating one example of a process for coupon use. At step 5-10 a coupon is presented to the merchant. At step 5-12, the coupon is scanned or read by the merchant. Next, a validation process is initiated (step 5-14). The validation process may include a comparison of scanned information with information stored in the application server database, such as transaction ID, checksum value, etc. If the application server 16 determines that the coupon is invalid (e.g., expired, counterfeit, already used, etc.), the coupon is refused (step 5-18) and the process ends. If the coupon is valid, the transaction is completed (step 5-20), and the user is given the discount specified on the coupon. At the same time, the application server 16 logs and processes the relevant debits and credits (step 5-22). For example, the merchant is debited an amount equal to the predetermined referral fee. The profile user that referred the user to the merchant is credited a portion of the fee from the merchant. Also, a commission may be paid to the person that signed the merchant up for the coupon system.

The following is a description illustrating how the present invention can enable a profile owner to add coupon content to the profile owner's hosted web page. Generally, the invention enables someone to add content to a web page, without altering the original web page as hosted by the website. Access to the edited content can be controlled so as to give desired people access to the extra hidden content. The invention provides the content owner with the greater control over the visibility, substance and portability of their online content and media assets.

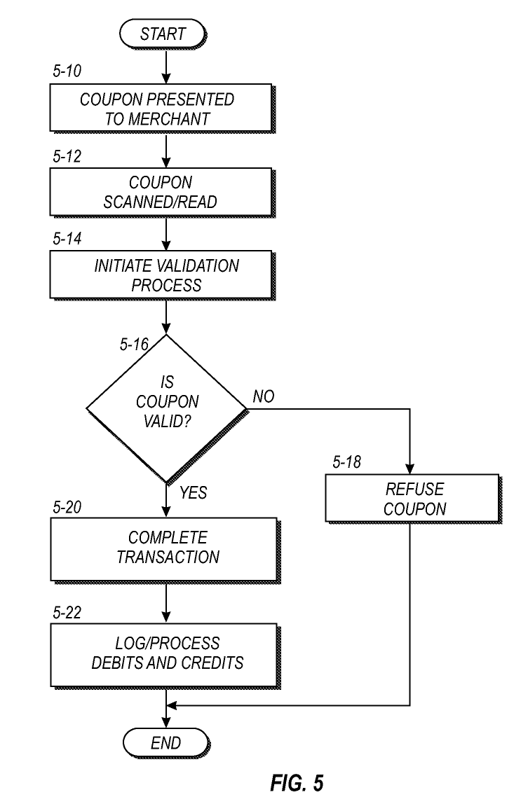

FIGS. 6-11 are diagrams illustrating how a profile owner can add content (including coupon content) to a web page, as well as illustrating how the content will look to another user. FIG. 6 is a diagram of a web browser 30, as it would be viewed by a user of a network client. FIG. 6 shows a typical web browser 30, which includes a browser window 32 for viewing web pages, as well as menus, buttons, an address line, and other items typically found in a standard web browser. FIG. 6 also shows a toolbar 34, which illustrates one example of how the present invention can be implemented. In this example, the toolbar 34 is a result of software installed on the network client, which controls the various functions of the present invention. The toolbar 34 includes various menus and buttons which can be configured to perform any desired functions. The invention may be implemented in any desired manner, including the use of a toolbar, a browser plug-in, and browser extension, local executable, active X control, etc.

Within the browser window 32 the contents of the current web page can be viewed. In the example shown in FIGS. 6-11, a typical profile web page from a social network is shown. FIG. 6 illustrates various contents of the profile web page, which can include text, graphics, media, etc. FIG. 6 shows various examples of generic content including text, images (the blocks with shading), and other generic content. Note that in this example, the web page shown in FIG. 6 in the browser window 32 is a web page retrieved from a web server, and is unaltered.

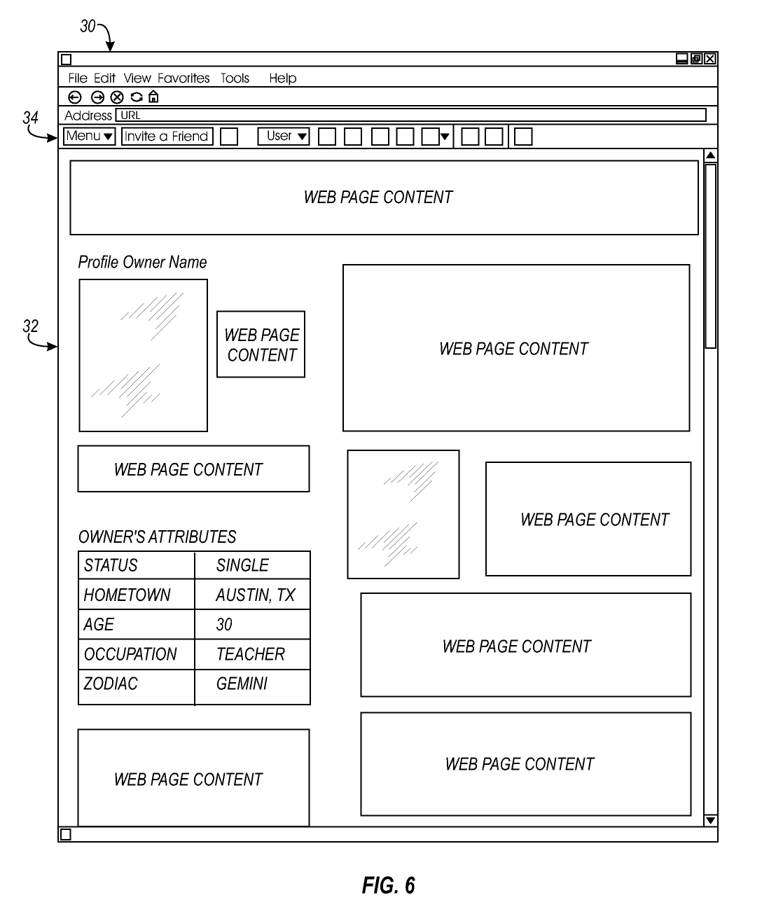

When the profile owner desires to add owner generated content, such as a coupon generator, the profile owner can click a button to place the current profile page into an edit mode. The button may be on a toolbar, or on the profile page, for example. FIG. 7 is a diagram of the Web browser 30, with the toolbar 34 placed in the edit mode. The toolbar 34 generates a menu 40 (labeled “Editors Palette”) which provides the profile owner with various options for adding content to the underlying profile page. In the example shown in FIG. 7, the profile owner can select either “add content,” “add mail form,” “add advertisement,” OR “add coupon.” Of course, any other desired options can be included in the menu 42. FIG. 7 also shows the addition of content anchor points 42 labeled “Drag Content Here” (described in more detail below). In this example, the two anchor points 42 shown are located in predetermined locations, based on site-specific scripts. In one example, site-specific scripts are provided by the application server (i.e., server side scripts) and are based on the host or domain of the web page being viewed. A site-specific script may be based on any desired component of a web page URL (e.g., host, domain name, sub domain, query string, etc.). An anchor point list may also be provided by an xpath provided in the site-specific script. Alternatively, the content locations could be chosen by the profile owner. The predetermined anchor points 42 in this example are located in certain areas that can be predetermined since the general web page layout of web pages in any particular social network host are known in advance.

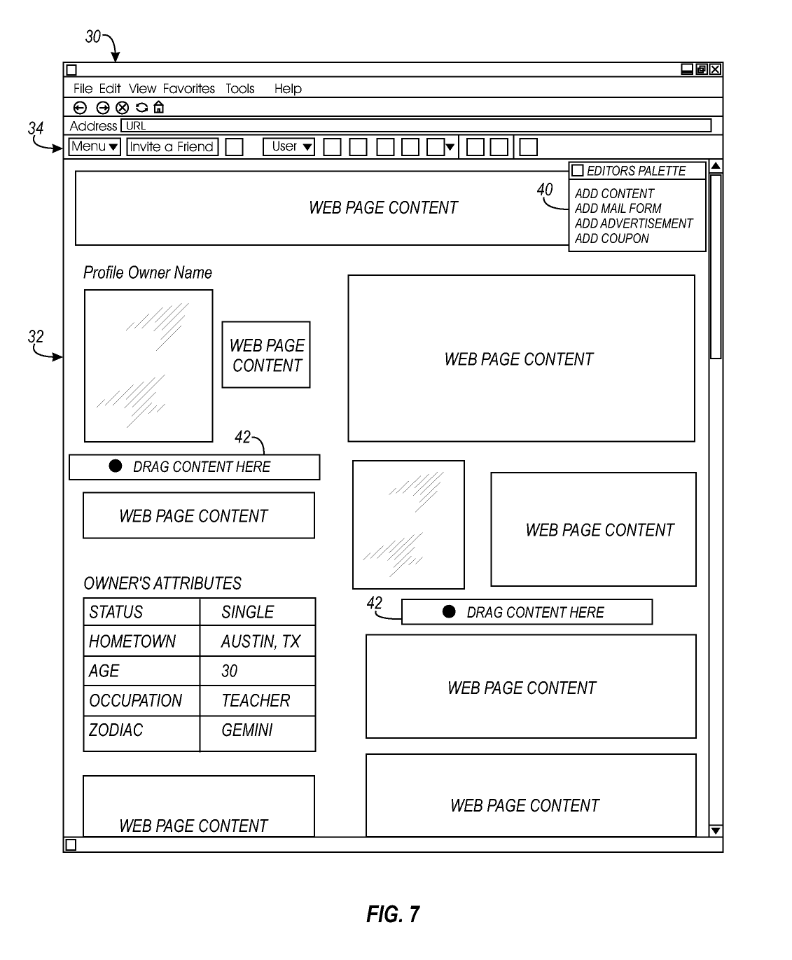

FIG. 8 is a diagram of the Web browser 30, illustrating the profile owner adding content. In this example, the profile owner selected “add coupon” in the menu 40. This action starts a coupon creation wizard and generates a coupon selection box (not shown), where the profile owner can select from a number of coupons for local businesses. In this hypothetical example, the profile owner selected a coupon for “Susie's Hair Salon” for a $6 hair styling discount on Tuesdays or Wednesdays. This action generates a content box 44 containing information relating to the coupon. In this example, the content box includes a title bar, text, and various buttons, including a print button. In one example, the buttons can be used to allow a user to print/process the coupon. The content box 44 also includes menus for allowing the profile owner to configure content visibility authentication options, such as passwords.

The profile owner has various options relating to where the generated content can be positioned. For example, the profile owner can configure the content to be a floating box such as the content box 44 as shown in FIG. 8. In one example, another user that can view the content box 44 when navigating to the profile owners web page is allowed to temporarily move the floating box where desired, although the content owner chooses the initial originating position of the content box 44 as seen by other users. Alternatively, the profile owner can choose to anchor the content at one of the anchor points 42.

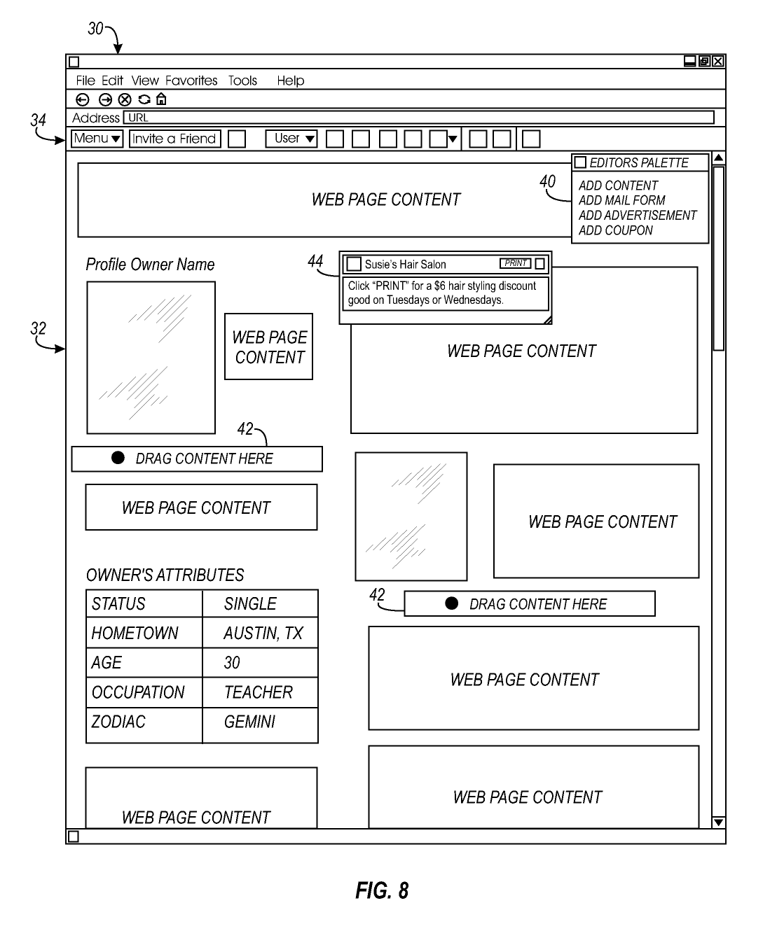

FIG. 9 is a diagram of the Web browser 30, as the profile owner drags the content box 44 toward one of the anchor points 42. As shown, when the content box 44 becomes close enough to the anchor point 42, an anchor box 46 appears (the dashed line). The content box 44 can be placed within the anchor box 46, which will cause the content box 44 to be anchored in place on the web page. Note that the original web page content is still there, but the page is adjusted to fit everything this user is authorized to see.

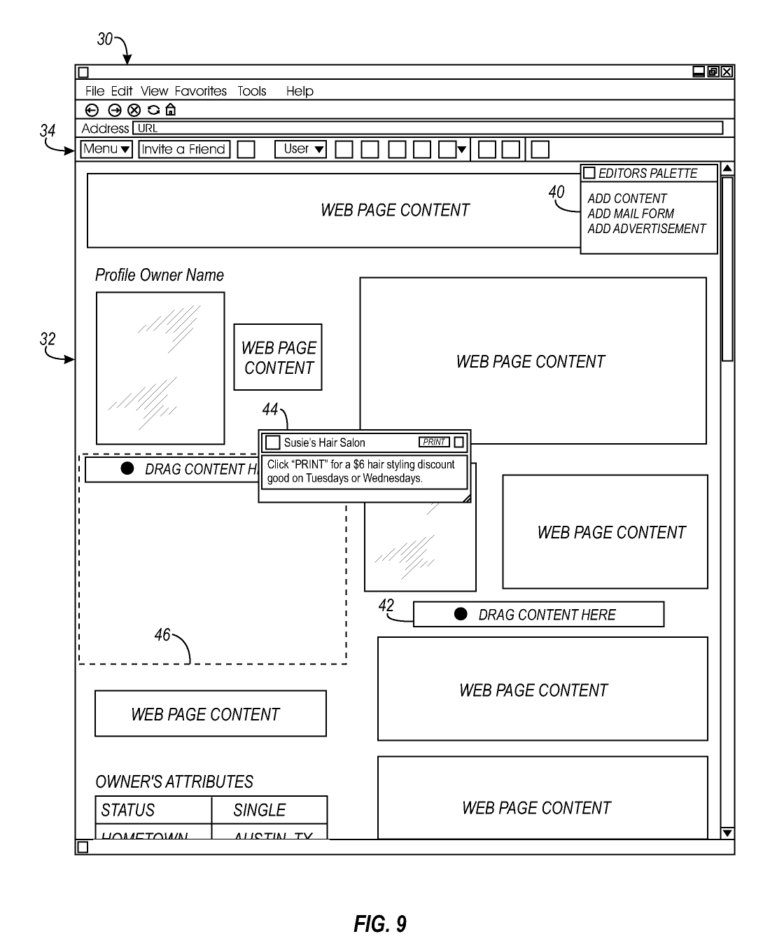

FIG. 10 is a diagram of the Web browser 30, after is the content box 44 has been anchored in place. As shown, the content is displayed inline with other content of the web page. Note that the invention also includes provisions to prevent the placement of user added content over such elements on the underlying web page as advertisements, security notices or other assets that are displayed on the originating web site. Additionally, the invention permits the viewers of added content to “tag it” (label it with meaningful search terms) for assistance locating it in the future, and also to help to prevent hate, porn, copyright infringement, etc.

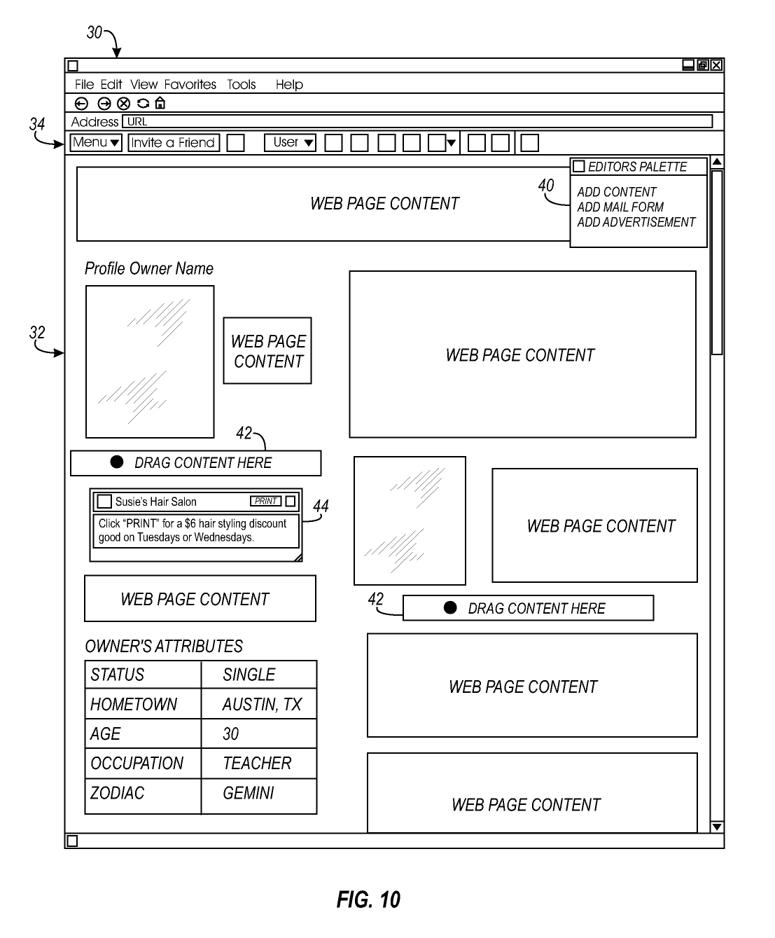

When the profile owner is finished adding the coupon content or editing existing content blocks, the invention will “publish” all changes back to the application server 16 and database 18. FIG. 11 is a diagram of the Web browser 30, illustrating the added content, after the profile owner published. FIG. 11 also illustrates what the customized web page will look like to another user that uses the toolbar 34, and is authorized to see the added content. In this example (what another user would see), a menu 52 (labeled with the mark “Social Palette™”) is also shown. The menu 52 may include various menu items. For example, the menu 52 can allow a user to add the currently viewed user profile to a friends list. Note again that all of the original web page content is still displayed, even after the user added content is injected into the web page.

Following is a hypothetical example of the invention described above. Of course, numerous other examples are also possible within the spirit and scope of the present invention. Assume that Mary uses the toolbar 34 shown in FIGS. 6-11 and described above to enhance her social networking experience. Mary also wants to take advantage of the coupon program enabled by the coupon production infrastructure described above. Mary uses the toolbar 34 to place the coupon widget for Susie's Hair Salon on her favorite social networking profile pages. Each person (that uses the toolbar 34) who visits her profile page can print the custom coupon, good for a $6 hair styling discount during Susie's slow periods on Tuesdays and Wednesdays. Each coupon generated has a barcode and optionally has a detachable portion for the consumer. The detachable portion can include a transaction ID, which allows customers to verify that the coupon was used, or to complain about poor service or misrepresentations in the transaction. Karen, Mary's friend, also uses the toolbar 34. When Karen views Mary's profile page, she sees the content illustrated in FIG. 11, including the Susie's coupon widget. Karen can generate the coupon from Mary's social networking page by clicking on the “PRINT” button shown in the content box 44, and then schedule her appointment at Susie's on Tuesday or Wednesday. The coupon can be printed on paper, or sent to Karen's PDA, phone, media player, etc., to be displayed when she arrives at Susie's. When Karen shows up at Susie's, the Susie's staff simply scans the coupon barcode, which verifies that the coupon is valid and has never been used before. In this example, Karen will get a $6 discount off of her hair styling and Susie's gets a customer during their slow time.

This scanning of the coupon logs the coupon consumption in the database 18. The application server then debits Susie's $5, for example, for the transaction. The $5 referral fee can be shared, as desired. In one example, the infrastructure provider keeps $1 (20%), credits Mary for a $3.50 referral fee (70%), and credits the person who “sold” Susie's on the coupon program $0.50 (10%). Of course, any desired compensation arrangement can be used. In one example, the person who signed Susie's up can receive a perpetual residual, i.e., 10% of every transaction that occurs for the merchant they recruited. The benefit to Susie's, compared to prior art marketing techniques is great. For a customer acquisition cost of $11 (the $6 discount, plus the $5 referral fee), Susie's hair salon was able to sell a $69 haircut at a time when they would have had no traffic. In addition, Susie's may have also added a regular customer for future visits.

Another feature of the present invention relates to the ability to search for merchants. As part of the “widget” placement layer, users that wish to place coupons on their profile pages are able to search for merchants and service providers by zip code, city, service type, merchant name or ID, etc. Such a search would give a user a list of local merchants who've provisioned referral offers sorted by the bounty amount and service type (e.g., restaurant, masseuse, etc). In one example a merchant might give a smaller credit when a coupon is printed but that scenario is more prone to fraud, but might be beneficial for certain types of merchants or certain demographics. Various features may be used to help detect fraud (non-scanning) on the part of our Merchants. For example, the database and application server can measure and report low “print to consume” ratio's (for that service type and market), as well as offering rewards for consumers who turn in non-scanning businesses by entering the transaction ID from their detachable portion of the consumed coupon.

In another example, when a user selects merchants, a filtering engine may be utilized to place multiple hidden coupon widgets on the user's profile page. Different coupon widgets will be visible to different users, depending on the users' profiles, demographics, etc. In other words, certain coupons will be visible to users that meet certain criteria, and other coupons will be visible to users that meet other criteria. For example, a coupon widget for a discount at a sporting goods store could be configured to be visible to users that have a profile that indicates interests in sports or outdoor activities. In another example, a coupon widget for a service provider may only be visible to users that live within the geographic area of the service provider. In another example, coupon widgets can be selected automatically, based on a user's profile or demographics.

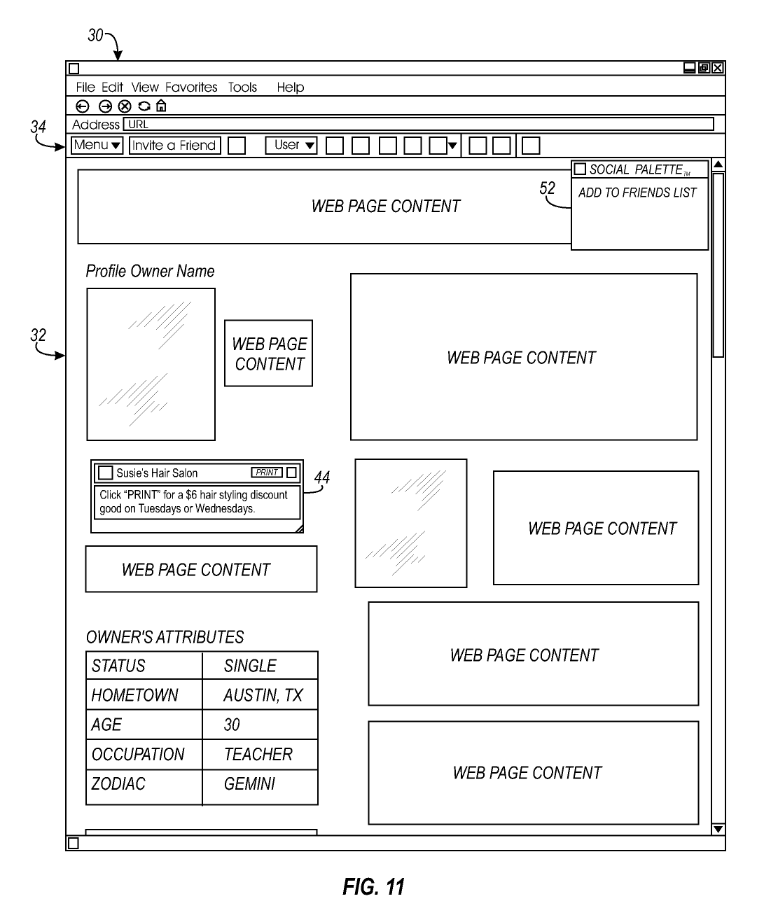

As mentioned above, a reader 22 can be used on conjunction with a network client (e.g., reader 22A), or can be a device that is a network client itself (e.g., reader client 22B). In one example, the reader 22B shown in FIGS. 1 and 2 is comprised of a web-ready barcode wand capable of communicating with the application server, web servers, network clients, etc. via a LAN, WAN, cellular network, pager network, bluetooth, etc. FIG. 12 is a block diagram of one example of a wireless handheld barcode scanner 102. The handheld barcode scanner 102 includes a sensor 104 adapted to scan barcodes or other machine readable information. A digital signal processor (DSP) 106 is used to perform the various processing tasks needed by the handheld barcode scanner 102. The DSP 106 is coupled to the sensor 104, a transceiver 108, memory 110, keypad 112, and display 114. An antenna 116 is coupled to the transceiver 108. When the barcode scanner 102 is used to scan a coupon, the sensor 104 reads the bar code on the coupon. The DSP 106 processes the sensed bar code, and generates a message that transmitted via the transceiver 108 and antenna 116 to the application server 16. Alternately, the message can be relayed through a local network client. The application server 16 will determine the validity of the coupon and send a reply message back to the barcode scanner 102, indicating whether the coupon is valid or not. The DSP 106 will process the reply message and display a message on the display 114, letting the merchant know whether the coupon is valid or not, and potentially the discount percent or amount.

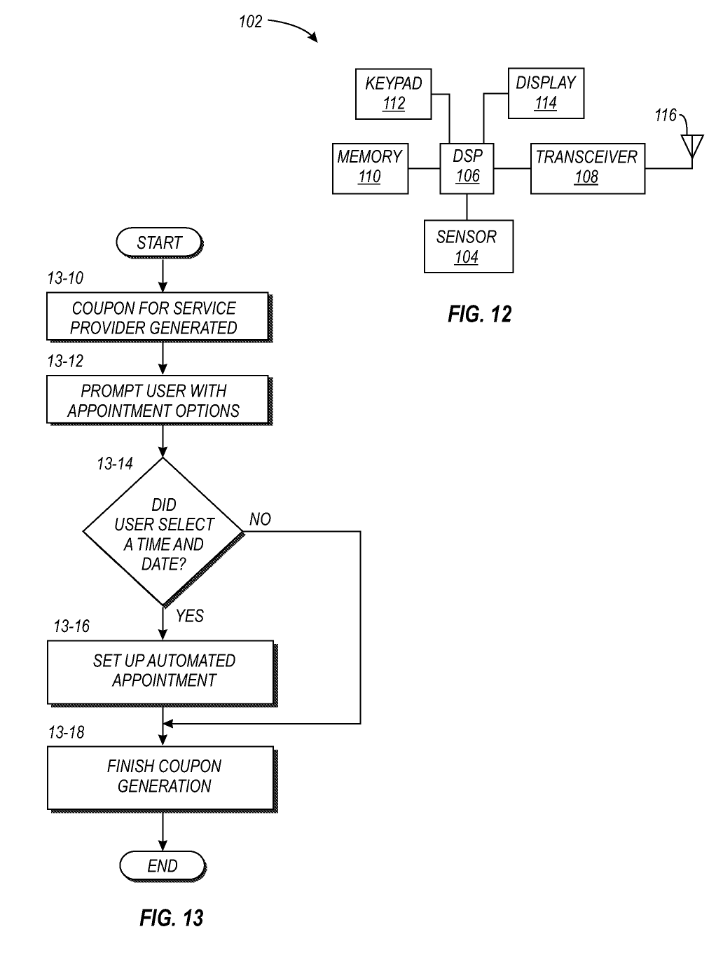

Another feature of the present invention relates to the automation of appointments. In one example, when a user generates a coupon for a service provider (e.g., by clicking on “PRINT”), the user is given the option of automatically setting an appointment with the service provider. If desired, the user can be prompted with one or more appointment dates/times and is asked to select or confirm a desired time. FIG. 13 is a flow chart illustrating a process for providing automated appointments. At step 13-10, a coupon for a service provider is generated, as described above. Next, at step 13-12, the user is prompted with appointment options. For example, the user could be asked whether they would like to set up an appointment. In another example, the user could be provided one or more available times to select from. At step 13-14, the process asks whether the user selected an appointment time and date. If not, the proceeds to step 13-18, and the coupon generation is finished. If the user does select a date and time, an automated appointment is set up at step 13-16. This step could be as simple as notifying the service provider that the user will arrive at a certain time. This step could also be more sophisticated, and the application server can communicate with the service provider's appointment management system to set up an appointment. Finally, at step 13-18, the coupon generation process is finished.

In the preceding detailed description, the invention is described with reference to specific exemplary embodiments thereof. Various modifications and changes may be made thereto without departing form the broader spirit and scope of the invention as set forth in the claims. The specification and drawings are, accordingly, to be regarded in an illustrative rather than a restrictive sense.

What is claimed is:

1. A method of facilitating a commercial transaction comprising:
providing a coupon production infrastructure allowing users to generate content that will be added to one or more web pages relating to a respective user when other users view the one or more web pages on an internet client;
allowing a first user to place content related to a coupon that will be associated with a first web page;
when a second user views the first web page using an internet client, adding the content placed by the first user, enabling the second user to view information relating to the content placed by the first user; and
allowing the second user to generate a coupon based on the viewed information.

2. The method of claim 2, further comprising automatically scheduling an appointment between the second user and a merchant associated with the coupon.

3. The method of claim 2, further comprising collecting a fee from a merchant who receives the coupon from the second user.

4. The method of claim 3, further comprising also sharing the fee with the first user.

5. The method of claim 4, further comprising tracking amounts owed to the first user.

6. The method of claim 4, further comprising also sharing the fee with a person responsible for affiliating the merchant with the coupon production infrastructure.

7. The method of claim 6, further comprising tracking amounts owed to the person responsible for affiliating the merchant with the coupon production infrastructure.

8. The method of claim 1, further comprising tracking consumption actions and validating the use of the coupon production infrastructure before generating the coupon.

9. The method of claim 1, further comprising allowing the coupon to be validated prior to its acceptance by a merchant.

10. The method of claim 9, wherein the coupon is validated using a barcode scanner capable of reading a bar code on the coupon.

11. The method of claim 1, wherein the generated coupon is a coupon printed on paper.

12. The method of claim 1, wherein the generated coupon is a coupon displayed on a display.

13. The method of claim 1, wherein the generated coupon is an entry in a database.

14. The method of claim 1, wherein the coupon is generated only after the second user completes one or more required steps.

15. The method of claim 14, wherein the one or more required steps includes viewing an advertisement.

16. The method of claim 14, wherein the one or more required steps includes viewing a video clip.

17. The method of claim 14, wherein the one or more required steps includes participating in a survey.

18. The method of claim 14, wherein the one or more required steps includes the referral of another user.

19. The method of claim 1, further comprising providing one or more processes for detecting fraud and penalizing merchant(s) associated with the coupon for failing to properly process all consumed coupons.

20. A wireless hand-held apparatus for facilitating commercial transactions comprising:
a processor for processing information;
one or more user interface devices;
a storage device for storing information;
a display for displaying information;
a sensor for reading machine readable information on a coupon generated by a customer in response to the customer viewing a profile page of a profile owner, wherein the coupon was generated based on coupon content added to the profile page by the profile owner; and
a transceiver for allowing the apparatus to communicate wirelessly with an application server, wherein the wireless hand-held apparatus communicates with the application server to verify the validity of the coupon.

21. The wireless hand-held apparatus of claim 20, wherein the sensor is comprised of a bar code reader.

22. The wireless hand-held apparatus of claim 20, wherein the sensor is comprised of a text scanner.

23. The wireless hand-held apparatus of claim 20, wherein the transceiver is configured to operate using a pager network.

24. An apparatus comprising:
an application server;
a database coupled to the application server for storing information relating to a plurality of profile owners, wherein for each of the plurality of profile owners, the database stores coupon related content selected by the respective profile owner, and wherein the stored coupon related content is intended to be displayable in conjunction with one or more web pages or profiles; and
wherein the application server is configured to receive requests from internet clients whether web pages identified by the web clients correspond to any web pages identified in the database, such that a web page can be displayed by a respective internet client with coupon related content added from the database.
